(19) United States
(12) Patent Application Publication
(10) Pub. No.: US 2022/0374935 A1
(43) Pub. Date: Nov. 24, 2022

(54) METHOD OF DEEP LEARNING USER INTERFACE AND AUTOMATICALLY RECOMMENDING WINNER OF DIFFERENT VARIANTS FOR USER INTERFACE BASED EXPERIMENTS

(71) Applicant: Samsung Electronics Co., Ltd., Suwon-si (KR)

(72) Inventors: Mahesh Kumar Kulkarni, Sunnyvale, CA (US); Sung Hyuck Lee, Menlo Park, CA (US); Sejin Choi, Mountain View, CA (US)

(21) Appl. No.: 17/655,322

(22) Filed: Mar. 17, 2022

Related U.S. Application Data
(60) Provisional application No. 63/192,355, filed on May 24, 2021.

(51) Int. Cl. G06Q 30/02; G06F 9/451

(52) U.S. Cl. CPC G06Q 30/0243; G06F 9/451

(57) ABSTRACT

A method, an electronic device and computer readable medium for A/B testing are provided. The method includes obtaining user interface (UI) variants and parameters for A/B testing. In response to obtaining the UI variants and the parameters, the method includes generating a score relating the UI variants and the parameters to extracted A/B testing data from previously performed A/B tests. The method also includes identifying a previous A/B test from the previously performed A/B tests that is similar to the UI variants and the parameters based on the score. The method further includes generating a result indicating whether one of the UI variants would win an A/B test without performing the A/B testing based on a comparison of one or more thresholds to similarities between the extracted A/B testing data of the previous A/B test and the UI variants and the parameters.

### CROSS-REFERENCE TO RELATED APPLICATION AND CLAIM OF PRIORITY

This application claims priority under 35 U.S.C. § 119(e) to U.S. Provisional Patent Application No. 63/192,355 filed on May 24, 2021. The above-identified provisional patent application is hereby incorporated by reference in its entirety.

### TECHNICAL FIELD

This disclosure relates generally to A/B testing. More specifically, this disclosure relates to deep learning user interface and recommending winner of different variants for user interface based experiments.

### BACKGROUND

The use of electronic devices has greatly expanded largely due to their usability, convenience, computing power, and the like. Methods for interacting with and controlling computing devices are continually improving, which has led to users expecting high-quality, and user-friendly environments. A/B testing is used to identify changes to the appearance of applications, web pages, and the like to determine which of two or more versions better accomplishes a particular goal of the experiment. For example, a project manager or designer of an application or web site can use A/B testing to identify aspects of an icon or user interface performs better based on which color selection, shape, location, or the like.

For A/B testing, a group of users are provided one option while another group of users are provided another option. Based on response that are received from the two groups, a conclusion is reached regarding which one of the options is to be rolled out based on the interface that better accomplished a particular goal of the experiment. Performing the A/B tests are time consuming as particular users need to be selected for each test group.

### SUMMARY

This disclosure provides systems and methods for deep learning user interface and recommending winner of different variants for user interface based experiments.

In a first embodiment, a method includes obtaining user interface (UI) variants and parameters for A/B testing. In response to obtaining the UI variants and the parameters, the method includes generating a score relating the UI variants and the parameters to extracted A/B testing data from previously performed A/B tests. The method also includes identifying a previous A/B test from the previously performed A/B tests that is similar to the UI variants and the parameters based on the score. The method further includes generating a result indicating whether one of the UI variants would win an A/B test without performing the A/B testing based on a comparison of one or more thresholds to similarities between the extracted A/B testing data of the previous A/B test and the UI variants and the parameters.

In a second embodiment, an electronic device includes a memory and a processor. The memory is configured to store extracted A/B testing data from previously performed A/B tests. The processor is configured to obtain UI variants and parameters for A/B testing. In response to the UI variants and the parameters being obtained, the processor is configured to generate a score relating the UI variants and the parameters to the extracted A/B testing data from the previously performed A/B tests. The processor is also configured to identify a previous A/B test from the previously performed A/B tests that is similar to the UI variants and the parameters based on the score. The processor is further configured to generate a result indicating whether one of the UI variants would win an A/B test without performing the A/B testing based on a comparison of one or more thresholds to similarities between the extracted A/B testing data of the previous A/B test and the UI variants and the parameters.

In a third embodiment, a non-transitory machine-readable medium contains instructions that, when executed, cause at least one processor of an electronic device to obtain UI variants and parameters for A/B testing. The medium also contains instructions that, when executed, cause the at least one processor to generate a score relating the UI variants and the parameters to extracted A/B testing data from previously performed A/B tests, in response to the UI variants and the parameters being obtained. The medium further contains instructions that, when executed, cause the at least one processor to identify a previous A/B test from the previously performed A/B tests that is similar to the UI variants and the parameters based on the score. Additionally, the medium contains instructions that, when executed, cause the at least one processor to generate a result indicating whether one of the UI variants would win an A/B test without performing the A/B testing based on a comparison of one or more thresholds to similarities between the extracted A/B testing data of the previous A/B test and the UI variants and the parameters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example network configuration including electronic devices in accordance with an embodiment of this disclosure;

FIG. 3A illustrates an example environment architecture of an A/B testing system in accordance with an embodiment of this disclosure.;

FIG. 3B illustrates an example process for A/B testing in accordance with an embodiment of this disclosure;

FIG. 4 illustrates an example reference table in accordance with an embodiment of this disclosure;

FIG. 5A illustrates an example process for analyzing user interface variants in accordance with an embodiment of this disclosure;

FIG. 5B illustrates an example method for identifying high performance A/B experiments in accordance with an embodiment of this disclosure;

FIG. 5C illustrates example user interfaces in accordance with an embodiment of this disclosure;

FIG. 5D illustrates an example heat map in accordance with an embodiment of this disclosure;

FIG. 6 illustrates an example method for generating a recommendation when a new A/B test is obtained in accordance with an embodiment of this disclosure; and

FIG. 7 illustrates an example method for A/B testing in accordance with an embodiment of this disclosure.

### DETAILED DESCRIPTION

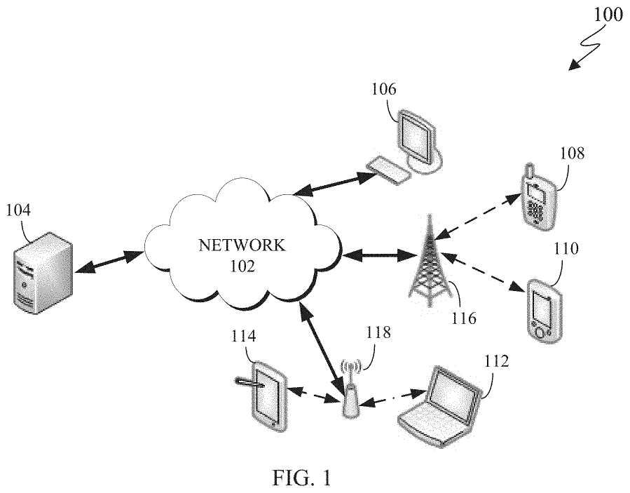

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

A user can view and interact with content displayed on a display of an electronic device. Common interactions include physical manipulations of the accessory, such as, a user physically moving the mouse, typing on the keyboard, touching the touch screen of a touch sensitive surface, among others. Methods for interacting with and controlling computing devices are continually improving, which has led to users expecting high-quality, and user-friendly user interface (UI) environments.

An electronic device, according to embodiments of the present disclosure can include a user equipment (UE) such as a 5G terminal. The electronic device can also refer to any component such as mobile station, subscriber station, remote terminal, wireless terminal, receive point, vehicle, or user device. The electronic device can be a mobile telephone, a smartphone, a monitoring device, an alarm device, a fleet management device, an asset tracking device, an automobile, a desktop computer, an entertainment device, an infotainment device, a vending machine, an electricity meter, a water meter, a gas meter, a security device, a sensor device, an appliance, and the like. Additionally, the electronic device can include a personal computer (such as a laptop, a desktop), a workstation, a server, a television, an appliance, and the like. In certain embodiments, an electronic device can be a portable electronic device such as a portable communication device (such as a smartphone or mobile phone), a laptop, a tablet, an electronic book reader (such as an e-reader), a personal digital assistants (PDAs), a portable multimedia player (PMP), an MP3 player, a mobile medical device, a virtual reality headset, a portable game console, a camera, and a wearable device, among others. Additionally, the electronic device can be at least one of a part of a piece of furniture or building/structure, an electronic board, an electronic signature receiving device, a projector, or a measurement device. The electronic device is one or a combination of the above-listed devices. Additionally, the electronic device as disclosed herein is not limited to the above-listed devices and can include new electronic devices depending on the development of technology. It is noted that as used herein, the term “user” may denote a human or another device (such as an artificial intelligent electronic device) using the electronic device.

As noted above, A/B testing is a method that compares two or more versions of a UI such as an application, web page, or the like, against each other version of the UI to determine which UI variant performs better with a subset of users. Additionally, parameters such as demographic information of users can affect which UI variant performs better. For example, certain demographic groups may prefer certain visual appearances over others. Demographic information can include age, location, gender, race, occupation, economic data, social data, and the like. Multivariate testing, also referred to as multinomial testing, is similar to A/B testing, but can test more than two versions at the same time or use more controls. As used herein A/B testing includes multivariate testing.

A project manager or designer of an application or website can use A/B testing to identify aspects of a UI (or such as an icon) that performs better based on a color selection, shape, location, size, font, or the like. Performance can be based on which icon was clicked more often during the A/B testing. For example, an icon of a certain color can cause users of a certain demographic (such as location, age, or the like) to click an icon more often as compared to an icon of another color for the same or similar demographic. The determination of which UI variant performs better can be based on statistical analysis.

To perform A/B testing, a group of users can be assigned a first UI while a second group of users can be assigned a second UI. Each of the two Uls can include one or more changes. The demographics of the users can be the same or different, based on the goal of the experiment. For example, if the goal experiment is to find which UI variant performs better with a certain group of persons then the demographics of the two groups should be similar. For instance, A/B testing can show that for shopping website in the United States of America a blue icon for purchasing an item is preferred (as a blue icon is clicked on more than when the icon is colored orange) while A/B testing of the same shopping website in India can show that an orange icon for purchasing an item is preferred (as the icon is clicked on more than when the icon is colored blue). In contrast, if the goal of the experiment is to find which UI variant performs better regardless of demographics, then the demographics of the two groups can be different.

A new A/B test for UI variants and parameters can be similar to previously performed A/B tests. For example, for a new A/B test of two UI variants and corresponding parameters can be similar to one or more A/B tests that were previously performed. When results of a previous A/B test are known, the project manager or designer of the new application or website can use the results of the previous A/B test. Using the results of the previous A/B test can save time and allow a quicker roll-out of the product.

Embodiments of the present disclosure take into consideration that, unless the project manager or designer of the new application or website is aware of the previously performed A/B test, a new A/B can be performed, causing a delay to rolling-out the new product. Additionally, the project manager or designer of the new application or website can spend significant amount of time researching previously performed A/B tests to identify a previously performed A/B test with similar demographic requirements was previously performed.

Certain embodiments of the present disclosure describe an A/B testing system that learns from past A/B tests to identify UI variants that performs better. Embodiments of this disclosure include systems and methods for providing insight indicating certain UI variants that perform better that other UI variants. The insight can also indicate whether certain demographic groups prefer certain UI variants. Embodiments of this disclosure include systems and methods for analyzing past A/B tests and extracting data from the previously performed A/B tests. Based on the extracted data, embodiments of this disclose describe determining whether a new A/B test is similar to any previously performed A/B tests. When a similar test was performed a recommended winner of the new A/B test can be generated, without needed to perform the new A/B test. Embodiments of this disclosure also include systems and methods for recommending changes to the UI variants of a new A/B test based on previously performed A/B tests. The changes can be recommending certain characteristics of the UI such as changing the location, size, shape, color of an icon.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate Internet Protocol (IP) packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head-mounted display (HMD), virtual assistant, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

The server 104 can represent an A/B testing system. For example, the server 104 can analyze previously performed A/B tests to extract high performing data. The server 104 can also obtain a new A/B test and compare the new A/B test with previously performed A/B tests. Based on the comparison, the server 104 can identify whether one of the UI variants of the new A/B test would win an A/B test without performing the A/B testing based on a comparison of the new A/B test with the previously performed A/B tests.

Each client device 106-114 represents any suitable computing or processing device that interacts with at least one server (such as the server 104) or other computing device(s) over the network 102. In this example, the client devices 106-114 include a desktop computer 106, a mobile telephone or mobile device 108 (such as a smartphone), a PDA 110, a laptop computer 112, and a tablet computer 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-114 communicate indirectly with the network 102. For example, the client devices 108 and 110 (mobile device 108 and PDA 110, respectively) communicate via one or more base stations 116, such as cellular base stations or eNodeBs (eNBs). Also, the client devices 112 and 114 (laptop computer 112 and tablet computer 114, respectively) communicate via one or more wireless access points 118, such as IEEE 802.11 wireless access points. Note that these are for illustration only and that each client device 106-114 could communicate directly with the network 102 or indirectly with the network 102 via any suitable intermediate device(s) or network(s).

In some embodiments, any of the client devices 106-114 transmits information securely and efficiently to another device, such as, for example, the server 104. Also, any of the client devices 106-114 can trigger the information transmission between itself and server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

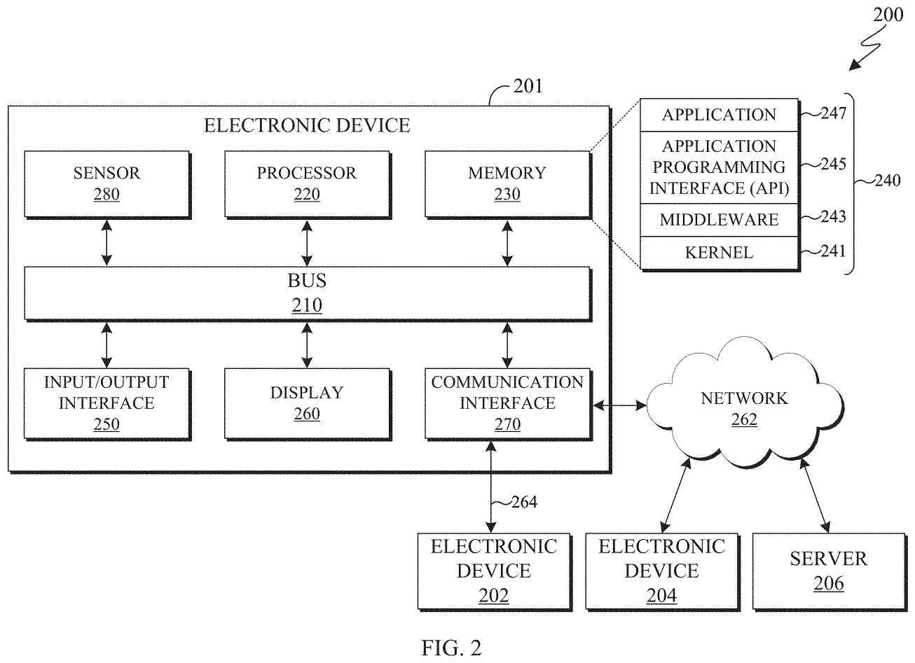

FIG. 2 illustrates an example network configuration 200 including electronic devices in accordance with this disclosure. The embodiment of the network configuration 200 shown in FIG. 2 is for illustration only. Other embodiments of the network configuration 200 could be used without departing from the scope of this disclosure.

According to embodiments of this disclosure, an electronic device 201 is included in the network configuration 200. The electronic device 201 can be the same as, or similar to, any of the client devices 106-114 of FIG. 1. In certain embodiments, the electronic device 201 is an A/B testing management device. The electronic device 201 can include at least one of a bus 210, a processor 220, a memory 230, an input/output (I/O) interface 250, a display 260, a communication interface 270, one or more sensors 280, a speaker, or a microphone. In some embodiments, the electronic device 201 may exclude at least one of these components or may add at least one other component. The bus 210 includes a circuit for connecting the components 220-280 with one another and for transferring communications (such as control messages and/or data) between the components.

The processor 220 includes one or more of a central processing unit (CPU), a graphics processor unit (GPU), an application processor (AP), or a communication processor (CP). The processor 220 is able to perform control on at least one of the other components of the electronic device 201 and/or perform an operation or data processing relating to communication. In certain embodiments, the processor 220 analysis previous A/B tests. In certain embodiments, the processor 220 is able to detect similarities between a new A/B test and previously performed A/B tests.

The memory 230 can include a volatile and/or non-volatile memory. For example, the memory 230 can store commands or data related to at least one other component of the electronic device 201. According to embodiments of this disclosure, the memory 230 can store software and/or a program 240. The program 240 includes, for example, a kernel 241, middleware 243, an application programming interface (API) 245, and/or an application program (or “application”) 247. At least a portion of the kernel 241, middleware 243, or API 245 may be denoted as an operating system (OS).

The kernel 241 can control or manage system resources (such as the bus 210, processor 220, or memory 230) used to perform operations or functions implemented in other programs (such as the middleware 243, API 245, or application 247). The kernel 241 provides an interface that allows the middleware 243, the API 245, or the application 247 to access the individual components of the electronic device 201 to control or manage the system resources. The application 247 includes one or more applications for A/B testing as discussed below. These functions can be performed by a single application or by multiple applications that each carries out one or more of these functions. The middleware 243 can function as a relay to allow the API 245 or the application 247 to communicate data with the kernel 241, for instance. A plurality of applications 247 can be provided. The middleware 243 is able to control work requests received from the applications 247, such as by allocating the priority of using the system resources of the electronic device 201 (like the bus 210, the processor 220, or the memory 230) to at least one of the plurality of applications 247. The API 245 is an interface allowing the application 247 to control functions provided from the kernel 241 or the middleware 243. For example, the API 245 includes at least one interface or function (such as a command) for filing control, window control, image processing, or text control.

The I/O interface 250 serves as an interface that can, for example, transfer commands or data input from a user or other external devices to other component(s) of the electronic device 201. The I/O interface 250 can also output commands or data received from other component(s) of the electronic device 201 to the user or the other external device.

The display 260 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 260 can also be a depth-aware display, such as a multi-focal display. The display 260 is able to display, for example, various contents (such as text, images, videos, icons, or symbols) to the user. The display 260 can include a touchscreen, which can receive, for example, a touch, gesture, proximity, or hovering input using an electronic pen or a body portion of the user.

The communication interface 270, for example, is able to set up communication between the electronic device 201 and an external electronic device (such as an electronic device 202, a second electronic device 204, or a server 206). For example, the communication interface 270 can be connected with a network 262 or 264 through wireless or wired communication to communicate with the external electronic device. The communication interface 270 can be a wired or wireless transceiver or any other component for transmitting and receiving signals, such as images.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 262 or 264 includes at least one communication network, such as a computer network (like a local area network (LAN) or wide area network (WAN)), Internet, or a telephone network.

The electronic device 201 further includes one or more sensors 280 that can meter a physical quantity or detect an activation state of the electronic device 201 and convert metered or detected information into an electrical signal. For example, one or more sensors 280 can include one or more cameras or other imaging sensors for capturing images of scenes. The sensor(s) 280 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 280 can further include an inertial measurement unit, which can include one or more accelerometers, gyroscopes, and other components. In addition, the sensor(s) 280 can include a control circuit for controlling at least one of the sensors included here. Any of these sensor(s) 280 can be located within the electronic device 201.

The external electronic device 202 and the external electronic device 204 can be the same as, or similar to, any of the client devices 106-114 of FIG. 1. The external electronic devices 202 and 204 can include the same or similar components 210-280 as the electronic device 201 (or a suitable subset thereof). The electronic device 201 can be directly connected with the electronic device 202 to communicate with the electronic device 202 without involving with a separate network.

The external electronic devices 202 and 204 and the server 206 each can be a device of the same or a different type from the electronic device 201. According to certain embodiments of this disclosure, the server 206 includes a group of one or more servers. The server 206 can be the same as, or similar to, the server 104 of FIG. 1. Also, according to certain embodiments of this disclosure, all or some of the operations executed on the electronic device 201 can be executed on another or multiple other electronic devices (such as the electronic devices 202 and 204 or server 206). Further, according to certain embodiments of this disclosure, when the electronic device 201 should perform some function or service automatically or at a request, the electronic device 201, instead of executing the function or service on its own or additionally, can request another device (such as electronic devices 202 and 204 or server 206) to perform at least some functions associated therewith. The other electronic device (such as electronic devices 202 and 204 or server 206) is able to execute the requested functions or additional functions and transfer a result of the execution to the electronic device 201. The electronic device 201 can provide a requested function or service by processing the received result as it is or additionally. To that end, a cloud computing, distributed computing, or client-server computing technique may be used, for example. While FIG. 2 shows that the electronic device 201 includes the communication interface 270 to communicate with the external electronic device 204 or server 206 via the network 262 or 264, the electronic device 201 may be independently operated without a separate communication function according to some embodiments of this disclosure.

The server 206 can include the same or similar components 210-280 as the electronic device 201 (or a suitable subset thereof). The server 206 can support to drive the electronic device 201 by performing at least one of operations (or functions) implemented on the electronic device 201. For example, the server 206 can include a processing module or processor that may support the processor 220 implemented in the electronic device 201. In certain embodiments, the server 206 manages the A/B testing.

In certain embodiments, the electronic device 201, the electronic device 202, the electronic device 204, the server 206, or a combination thereof can include a neural network for machine learning.

Although FIG. 2 illustrates one example of a network configuration 200 including an electronic device 201, various changes may be made to FIG. 2. For example, the network configuration 200 could include any number of each component in any suitable arrangement. In general, computing and communication systems come in a wide variety of configurations, and FIG. 2 does not limit the scope of this disclosure to any particular configuration. Also, while FIG. 2 illustrates one operational environment in which various features disclosed in this patent document can be used, these features could be used in any other suitable system.

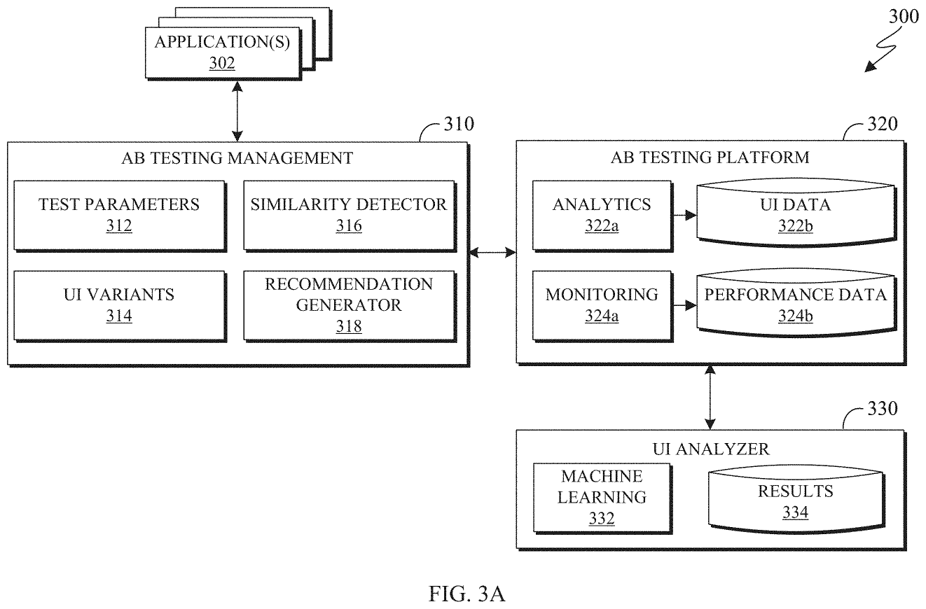

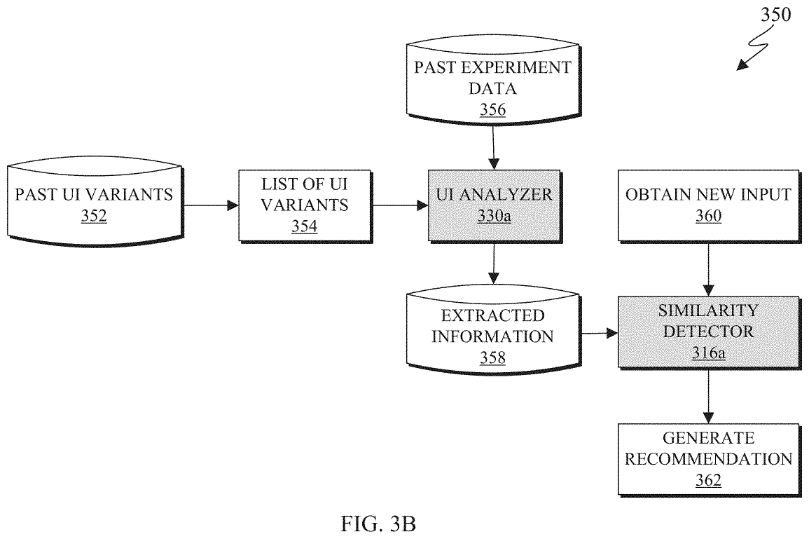

FIG. 3A illustrates an example environment architecture of an A/B testing system 300 in accordance with an embodiment of this disclosure. FIG. 3B illustrates an example process 350 for A/B testing in accordance with an embodiment of this disclosure.

The A/B testing system 300 and the process 350 are described as being implemented any of the client devices 106-112 or the server 104 of FIG. 1, the electronic device 201 or the server 206 of FIG. 2, or any combination thereof. For example, the server 206 of FIG. 2 can include the A/B testing system 300. However, the A/B testing system 300, the process 350, or both can be used by any other suitable device(s) and in any other suitable system(s). The A/B testing system 300 is described as being used to perform A/B testing. Upon a detection of a previously performed A/B test which is similar to an obtained A/B test, the A/B testing system 300 can notify the user of the previously performed A/B test that is similar to obtained UI variants, recommend a winner of the obtained UI variants without performing an A/B test, or perform an A/B test based on the obtained UI variants, or a combination thereof. However, the A/B testing system 300 can be used to perform any other suitable task.

The A/B testing system 300 of FIG. 3 includes an A/B testing management engine 310, an A/B testing platform 320, and a UI analyzer 330. The A/B testing system 300 also includes information repositories such as the UI data 322b and the performance data 324b of the A/B testing platform and the results 334 of the UI analyzer 330. These information repositories can be the same as, or similar to, the memory 230 of FIG. 2.

Information repositories represents any structure(s) capable of storing and facilitating retrieval of information (such as data, program code, or other suitable information on a temporary or permanent basis). The information repositories can include a memory and a persistent storage. Memory can be RAM or any other suitable volatile or non-volatile storage device(s), while persistent storage can contain one or more components or devices supporting longer-term storage of data, such as a ROM, hard drive, Flash memory, or optical disc. The information repositories can store data obtained by a user such as the applications 302, test parameters 312, A/B test results, and the like.

As illustrated, the A/B testing management engine 310 obtains one or more applications 302 for A/B testing. The applications 302 include various versions of an application. For example, different UI variants can be included in each of the applications 302 for A/B testing. In certain embodiments, the applications 302 have different looks and feels such as different Uls. For example, content in each of the applications 302 can have different placements, sizes, colors, or the like.

In certain embodiments, the A/B testing management engine 310 is a visual dashboard. The A/B testing management engine 310 enables a user, such as a program or application developer, to input parameters for the A/B testing and view results of a performed A/B test. The A/B testing management engine 310 includes test parameters 312, UI variants 314, a similarity detector 316, and a recommendation generator 318.

The test parameters 312 enable a user to input certain parameters for A/B testing. The parameters can include information such as defining the life cycle of the A/B test experiment associated with the applications 302. For example, a user can specify how long the A/B testing is to be performed, when the A/B test is to start, when the A/B test is to conclude, or the like. The parameters can also include user assignment and segmentation information. For example, the user can specify certain demographic information on which to test the UI variants. The user can indicate certain demographic information, such as age and gender (among others), of persons that are to view the different applications 302 for performing the A/B testing.

The UI variants 314 identify the differences between the applications 302. For example, for an A/B test between two applications, one of the applications 302 can have a red colored icon while another one of the applications 302 can have a green colored icon. The UI variants 314 identifies the differences between the two applications for the A/B test. In certain embodiments, more than two differences are included in the applications 302. When more than two differences are included in the applications 302, the UI variants 314 identifies all of the differences between the applications.

The similarity detector 316 identifies similar UI variants and parameters from past experiments (A/B tests) to the current experiment (the UI variants 314 based on the applications 302 and the test parameters 312). Upon identifying a similar A/B test, the similarity detector 316 can generate a confidence score relating the current and previous A/B tests.

In certain embodiments, the similarity detector 316 compares previously performed A/B tests to the UI variants of the applications 302 (as identified by the UI variants 314), the test parameters 312 (as obtained from the user). In certain embodiments, after the A/B testing management engine 310 obtains information for a new A/B test, including the applications 302 and the test parameters 312, the similarity detector 316 compares extracted A/B testing data from previously performed A/B tests with to the new A/B test. The previously performed A/B tests, the extracted A/B testing data, or both are stored in information repositories, such as the UI data 322b, the performance data 324b, the results 334, or any combination thereof.

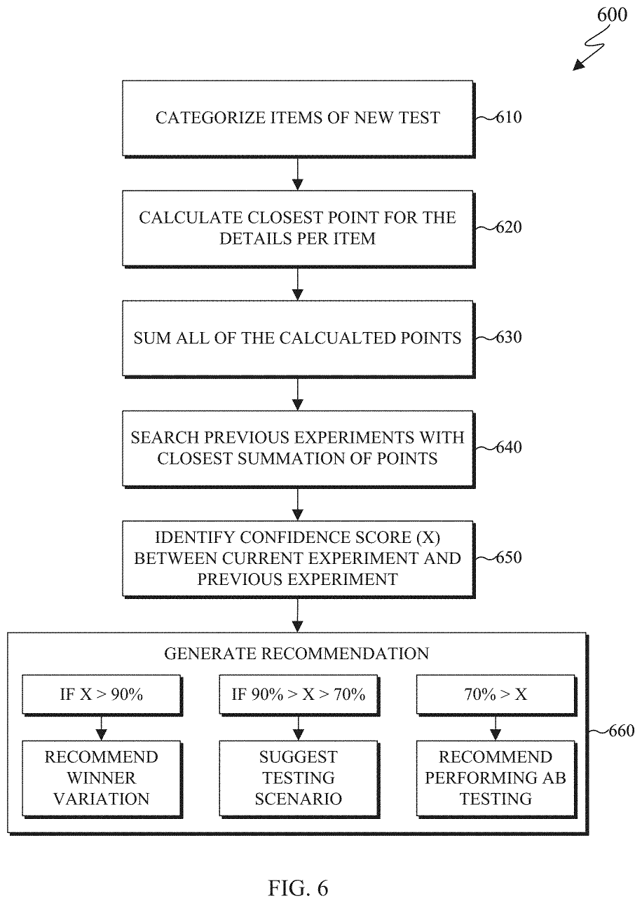

The similarity detector 316 can identify a previously performed A/B test that is similar to the new A/B test. If the similarity detector 316 identifies a previously performed A/B test that is similar to the new A/B test, the similarity detector 316 compares the two tests and generates a confidence score. The confidence score indicates how similar the UI variants of the previously performed A/B test are to the new A/B test. The confidence score also indicates how similar the parameters of the previously performed A/B test are to the new A/B test. In certain embodiments, the higher the confidence score the more similar the previously performed A/B test is to the new A/B test. The similarity detector 316 is described in greater detail below in FIGS. 3B and 6.

The recommendation generator 318 generates a recommendation based on the results of the similarity detector 316. In certain embodiments, the recommendation generator 318 predicts a winner of a new A/B test based on a level of similarity between the new A/B test and a previously performed A/B test. For example, if the previously performed A/B test is similar to the new A/B test (as identified by the similarity detector 316), the recommendation generator 318 can predict which one of the two applications 302 would win if an A/B test was performed on the new UI variants based on the results of the previous A/B test.

If the similarity detector 316 identifies a previously performed A/B test that is similar to the new A/B test and the confidence score is above a first threshold, the recommendation generator 318 generates a first result. The first result can recommend a winner of the new A/B test without performing an A/B test on the applications 302. For example, the recommendation generator 318 can recommend a winner of the new A/B test based on the winner of the previously performed A/B test. Based on the recommendation, the user can determine either to accept the recommended winner or perform the A/B test.

If the similarity detector 316 determines that none of the previously performed A/B tests are similar to the new A/B test, the recommendation generator 318 generates a second result. The second result can specify that no previously performed A/B test is similar to the new A/B test and recommend performing an A/B test for the new UI variants and parameters.

If the similarity detector 316 identifies a previously performed A/B test that is similar to the new A/B test and the confidence score is below a second threshold (where the second threshold is different than the first threshold), the recommendation generator 318 generates another result. This result can be similar to the second result. For example, the recommendation generator 318 can recommend performing an A/B test for the new UI variants and parameters since confidence score is below the second threshold.

If the similarity detector 316 identifies a previously performed A/B test that is similar to the new A/B test and the confidence score is between a third threshold, the recommendation generator 318 generates yet another result. In certain embodiments, the third threshold represents values between the first and second thresholds. This result can include a recommendation to change one or more of the test parameters 312, the UI variants or both, in order to modify the new A/B test. The recommendations can bring the new A/B test closer to the identified A/B test that was previously performed. For example, if the user accepts one or more of the recommendations and modifies the new A/B test, the similarity detector can update is confidence score. If the confidence score increases to a value that is above the first threshold, the recommendation generator 318 generates the first result indicating which of the variants would win an A/B test without performing the A/B test. The recommendation generator 318 is described in greater detail below in FIGS. 3B and 6.

The A/B testing platform 320 performs an A/B test based on the test parameters 312 and the UI variants 314 from the obtained applications 302. In certain embodiments, the A/B testing platform 320 oversees a requested A/B test and returns the results of the test to the A/B testing management engine 310. The results indicate which one of the two applications 302 performed better based on the requested test parameters 312. Based on the results, the user, such as the project manager or designer can then roll-out the winning UI variants. The A/B testing data includes an analytics engine 322a and a monitoring engine 324a.

The analytics engine 322a can select certain persons to be in Testing Group A and Testing Group B based on the test parameters. For example, the persons in Testing Group A and Testing Group B can be in similar demographic groups as specified by the test parameters 312. Testing Group A can be given one of the applications 302 and Testing Group B can be given another one of the applications 302. The analytics engine 322a can store application event data in an information repository, such as the UI data 322b. The UI data 322b can be a memory the same as, or similar to, the memory 230 of FIG. 2. In certain embodiments, the UI data 322b includes information describing the UI variants 314 and the test parameters 312. For example, the UI data 322b can store the parameters associated with the experiment, different UI variants (such as size, color, location, and the like), specify distinguishing characteristics between the different UI variants, or the like.

The monitoring engine 324a monitors an ongoing A/B test experiment. The results of the test can be stored in an information repository, such as the performance data 324b. The performance data 324b can be a memory the same as, or similar to, the memory 230 of FIG. 2. In certain embodiments, the monitoring engine 324a oversees the ongoing A/B test experiment and tallies the number of interactions each UI variants have in each of the groups. Based on the tallies a wining UI variant can be declared. For example, the UI variants that was interacted with the most can be declared a winner as it was more user-friendly, attracted more user interaction, or the like.

The UI analyzer 330 analyzes differences between the different UI variants and their performances from past A/B tests. The UI analyzer 330 includes a machine learning 332. In certain embodiments, the machine learning 332 analyzes UI differences, UI variances, and their performances from previously performed A/B tests. The machine learning 332 extracts the results from the previously performed A/B tests. The extracted results can be stored in an information repository, such as the results 334. The results 334 can be a memory the same as, or similar to, the memory 230 of FIG. 2. The extracted results 334 can also include information about the UI variants as well. For example, the extracted results 334 can indicate whether the UI variances are associated with a button, icon, a menu, a background, an executing application or the like. The extracted results 334 can indicate the color of the UI element, a size of the UI element, the purpose of the UI element and the like.

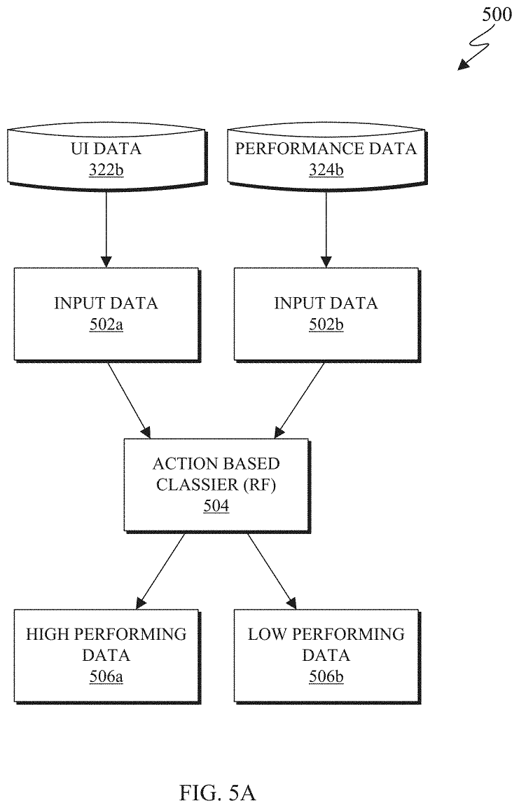

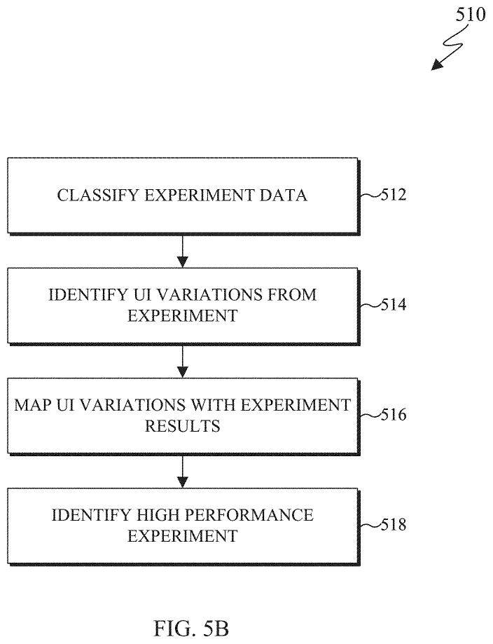

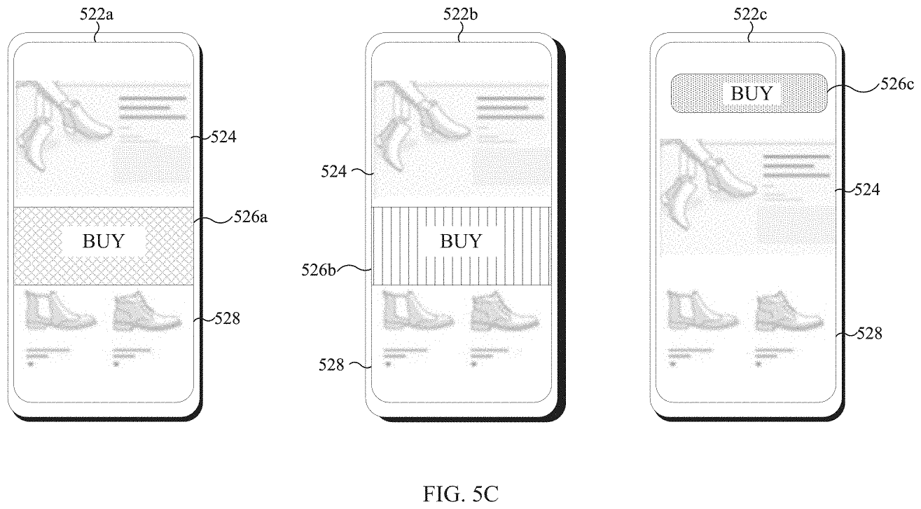

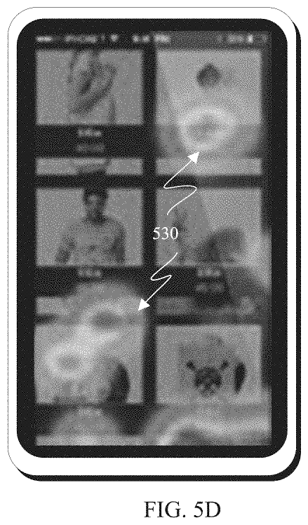

The machine learning 332 can also look at past A/B test results such as did a user click on the button or image, how many times was the button or image interacted with, and the like. In certain embodiments, the machine learning 332 generates a heat map indicating how many times a UI item (such as an icon) was interacted with. An example heat map is illustrated in FIG. 5D.

In certain embodiments, the machine learning 332 analyzes the UI components that are different between UI variants of an A/B test and the parameters associated therewith using a machine learning classifier. For example, the machine learning 332, using a machine learning classifier, can determine that an icon of a certain color at a certain location of the display can perform better than an icon of the same color at a different location with certain demographics. In another example, the machine learning 332, using a machine learning classifier, can determine that an icon of a certain color at a certain location of the display can perform better than an icon of a different color at the same location with certain demographics. The machine learning 332 can also extrapolate whether the purpose of an icon (such as whether the icon opens a menu is a call to action (CTA), an image, or the like. The machine learning 332 can identify high and lower performing data using the machine learning classifier.

In certain embodiments, the machine learning classifier is an action based classifier. For example, the machine learning 332 can identify the UI differences between two applications of previously performed A/B tests and identify what elements in those applications makes were commonly found in the winning application for a given set of testing parameters. The machine learning 332 uses the past A/B tests performed by the A/B testing platform 320 as training data for the machine learning classifier. The UI analyzer 330 is described in greater detail below in FIGS. 3B, 5A, and 5B.

The process 350, as illustrated in FIG. 3B, is generally used A/B testing. For example, the process 350 can be used for extracting A/B testing data from previously performed tests and using the extracted data for generating recommendations when a request for a new A/B test is obtained.

As illustrated, an information repository 352 stores past UI variants. The information repository 352 can be a memory that is the same as, or similar to, the UI data 322b of FIG. 3A. The past UI variants can be UI variants of previously performed A/B tests. The information repository 352 can also store test parameters associated with the UI variants of previously performed A/B tests. A list of the UI variants 354 stored in the information repository 352 can be generated. The generated list of UI variants 354 can be used as an input to the UI analyzer 330a. The UI analyzer 330a is similar to the UI analyzer 330 of FIG. 3A. The UI analyzer 330a using the list of UI variants 354 and past experiment data 356 generates the extracted information 358 which is stored in an information repository. The past experiment data 356 can be stored in an information repository and similar to the performance data 324b of FIG. 3. In certain embodiments, the past experiment data 356 includes past experiment feedback and user demographic data. The UI analyzer 330a identifies feedback information from the past experiment data 356 associated with each UI variant. For example, the UI analyzer 330a extracts information 358 associated with each UI variant for identifying variants that perform well with certain demographics.

When a new input 360 is obtained, the similarity detector 316a compares the extracted information 358 to the new input 360. The new input 360 can include UI variants and test parameters (such as the test parameters 312 including information such as defining the life cycle of the A/B test experiment and demographic information). The similarity detector 316a can be similar to the similarity detector 316 of FIG. 3A.

The similarity detector 316a determines whether one of the previously performed A/B tests from the extracted information 358 is similar to the new input 360. A result 362 is generated based on the output of the similarity detector 316a. For example, if no match is found, the result 362 can indicate that a new A/B test should be performed. The results of the new A/B test can be added to the information repository 352 and eventually analyzed by the UI analyzer 330a. Alternatively, if a match is found, the result 362 can recommend a winner (based on the previously performed A/B test) or include recommendations to guide the A/B testing details for better results.

Although FIG. 3A illustrates one example A/B testing system 300 and the FIG. 3B illustrates an example process 350 for A/B testing, various changes may be made to FIGS. 3A and 3B. For example, the A/B testing system 300 can receive and process various types of inputs. Also, the tasks performed using the A/B testing system 300 and the recommendations generated by the process 350 can include additionally recommendations. In another example, while shown as a series of steps, various steps in FIG. 3B could overlap, occur in parallel, or occur any number of times.

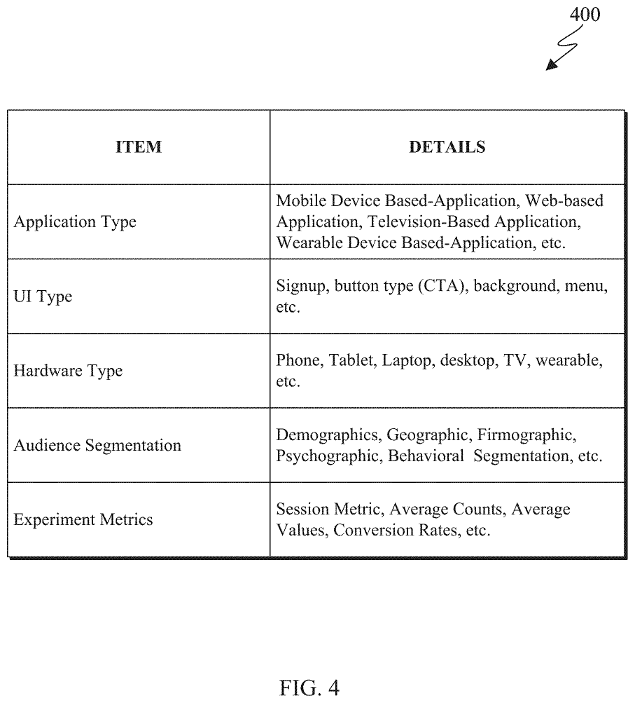

FIG. 4 illustrates an example reference table 400 in accordance with an embodiment of this disclosure. The embodiment of the reference table 400 shown in FIG. 4 is for illustration only. Other embodiments could be used without departing from the scope of the present disclosure.

The reference table 400 can be generated by any of the client devices 106-112 or the server 104 of FIG. 1 or the electronic device 201 or the server 206 of FIG. 2. The reference table 400 can be included in an electronic device that performs the A/B testing. However, the reference table 400 can be used by any other suitable device(s) and in any other suitable system(s).

Each previously performed A/B test and new A/B test can be organized into a reference table such as the reference table 400 as illustrated in FIG. 4. By organizing previously performed A/B test and new A/B test into the reference table 400, enables the similarity detector 316 and 316a of FIGS. 3A and 3B, respectively, to find similar past experiments to the new A/B test. As illustrated, the reference table 400 includes two columns a first column defining an item and a second column defining details of the corresponding items. The content in the first column and the details in the second column shown in FIG. 4 illustrates one specific example of items and details, respectively. For example, more or less items and corresponding details defining an A/B test can be included.

The first column includes specifies “application type,” “a UI type,” a “hardware type,” “audience segmentation,” “experiment metrics,” and the like. For example, the “application type” specifies what the application 302 is used for. For example, the application cab be used on a mobile-based application, a web-based application, a television-based application, a wearable device-based application, or the like. The “UI type” specifies what the UI is used for. For example, the UI can be a sign up button, CTA button, a background, a menu button, text, or the like. The “hardware type” specifies what type of device the application is running on. The hardware type can include a mobile device (such as the mobile device 108 of FIG. 1), a tablet (such as the tablet computer 114 of FIG. 1), a laptop computer (such as the laptop computer 112 of FIG. 1), a desktop computer (such as the desktop computer 106 of FIG. 1), a wearable device (such as a watch), or the like. The “audience segmentation” specifies information about the persons who performed the A/B test of a given UI variant. For example, the “audience segmentation” can specify demographic information, geographic infroaktion, firmographic information, psychographic information, behavioral information, segmentation information and the like of the persons who performed the A/B test. The “experiment metrics” specifies information about how the information was gathered for a winning UI variant. For example, the “experiment metrics” can include session metrics, average counts, average values, conversion rates, and the like.

Although FIG. 4 illustrates one example of the reference table 400, various changes may be made to FIG. 4. For example, the reference table 400 can include more or less than items and corresponding details.

FIG. 5A illustrates an example process 500 for analyzing user interface variants in accordance with an embodiment of this disclosure. FIG. 5B illustrates an example method 510 for identifying high performance A/B experiments in accordance with an embodiment of this disclosure. FIG. 5C illustrates example user interfaces in accordance with an embodiment of this disclosure. FIG. 5D illustrates an example heat map in accordance with an embodiment of this disclosure.

The process 500 for analyzing user interface variants and the method 510 for identifying high performance A/B experiments are described as being performed by any of the client devices 106-112 or the server 104 of FIG. 1, the electronic device 201 or the server 206 of FIG. 2, or any combination thereof. For example, the server 206 of FIG. 2 performs the process 500 and the method 510. However, process 500, the method 510, or both can be used by any other suitable device(s) and in any other suitable system(s).

The process 500 as illustrated in FIG. 5A, is generally used by the UI analyzer 330 of FIG. 3A for identifying high and lower performing data. In this example, the UI data 322b and the performance data 324b are the same as the UI data 322b and the performance data 324b of FIG. 3A. As described above, the UI data 322b includes UI variants of previously performed A/B tests as well as testing parameters while the performance data 324b includes A/B results of the previously performed A/B tests.

The UI analyzer 330 converts the data stored in the UI data 322b into input data 502a for a machine learning classifier. Similarly, the UI analyzer 330 converts the data stored in the performance data 324b into input data 502b for a machine learning classifier. The input data 502a and 502b include training data, text, images, UI information (such as color, position, purpose), application type, device type, and the like.

A machine learning classifier 504 compares the input data 502a and 502b and generates a list of high performing data 506a and a list of low performing data 506b. In certain embodiments, the machine learning classifier 504 is an action based classifier. In certain embodiments, the machine learning classifier 504 is an action based classifier that uses a random forest classifier for classifying the input data 502a and 502b.

The machine learning classifier 504 generates the list of high performing data 506a and the list of low performing data 506b. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The method 510 of FIG. 5B describes the process of the machine learning classifier 504 generating the lists of the high and low performing data 506a and 506b, respectively. The lists of the high and low performing data 506a and 506b can be stored in the results 334 of FIG. 3A. In certain embodiments, a reference table, such as the reference table 400 of FIG. 4 can be generated for each of the high performing data 506a.

The method 510 of FIG. 5B can be performed by the machine learning classifier 504 of FIG. 5A. In step 512, the machine learning classifier 504 classifies the experiment data. The experiment data includes the information from the previously performed A/B tests. In certain embodiments, machine learning classifier 504 classifies the experiment data of each test into item of a reference table, such as the reference table 400 of FIG. 4. For example, the information from for a single A/B test that was previously performed, can be classified according to a reference table.

In step 514, the machine learning classifier 504 identifies UI variations from each of the previously performed A/B tests. The machine learning classifier 504 can generate a heat map indicating locations and how many times a UI item (such as an icon) was interacted with during the A/B testing process.

In step 516, the machine learning classifier 504 maps the UI variations with results of the A/B tests. In step 518, the machine learning classifier 504 generates a high performance table, based on the results of step 516. The high-performance table can be similar to the high performing data 506a of FIG. 6. The high-performance table can resemble the reference table 400 of FIG. 4 indicating that certain UI variants are preferred based on certain application types, UI types, hardware types, audience segments and the like.

FIG. 5C illustrates user interfaces 522a, 522b, and 522c of an electronic device (such as any of the client devices 106-114, or the electronic device 201 of FIG. 2). A designer can select two or more of the user interfaces for A/B testing. As described above, A/B testing compares two UIs, however each of the UIs can include multiple differences. For example, an A/B test can compare the user interface 522a with the user interface 522b. In another example, an A/B test can compare the user interface 522a with the user interface 522c. In yet another example, an A/B test can compare the user interface 522b with the user interface 522c.

As illustrated, the user interfaces 522a, 522b, and 522c include an item 524 for sale with an icon 526a, 526b and 526c, respectively, representing an action button for purchasing the item 524. Additionally, the user interfaces 522a, 522b, and 522c include item 528 for selecting another item to view and possible purchase. The icons 526a and 526b are located in the similar position on the UI. Additionally, the icons 526a and 526b are similarly sized. However, the icon 526a is a different color/texture and the icon 526b. The icon 526c is positioned at a different location, is a different size, and a different color/texture than the icons 526a and 526b. However, the purpose of the icons 526a-526c are the same, that of purchasing the item 524. It is noted that icons 526a-526c can include more differences and that more UI variants can be included in each of the user interfaces 522a-522c.

FIG. 5D illustrates an example electronic device with an example heat map overlaying a user interface. A heat map is a visualization technique used to show a magnitude of interactions at certain locations of a display. Variations in color can indicate the number of interactions at a particular location of the display. The heat map shows areas 530 where a user touched particular icons that are displayed. As more interactions at a particular location of the screen occur, the more vibrant the areas 530 become. The machine learning classifier 504 can use the location and a number of interactions when identifying UI variations from each of the previously performed A/B tests.

Although FIG. 5A illustrates the process 500 for analyzing user interface variants, the FIG. 5B illustrates the method 510 for identifying high performance A/B experiments, FIG. 5C illustrates example user interfaces, and FIG. 5D illustrates an example heat map, various changes may be made to FIGS. 5A-5D. For example, the process 500 can use different classifiers for identifying performance data from previous A/B tests. In another example, FIG. 5C can include more or less user interfaces variants. In yet another example, while shown as a series of steps, various steps in FIGS. 5A and 5B could overlap, occur in parallel, or occur any number of times.

FIG. 6 illustrates an example method 600 for generating recommendations when a new A/B test is obtained in accordance with an embodiment of this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a processor chain in, for example, one of the client devices 106-112 or the server 104 of FIG. 1.

The method 600 for generating recommendations are described as being performed by any of the client devices 106-112 or the server 104 of FIG. 1, the electronic device 201 or the server 206 of FIG. 2, or any combination thereof. For example, the server 206 of FIG. 2 performs the method 600. The method 600 can be used by any other suitable device(s) and in any other suitable system(s).

The method 600 can be performed by the similarity detector 316 and the recommendation generator 318 of FIG. 3A. In step 610, the similarity detector 316 categorizes the information of the new A/B test into a reference table, such as the reference table 400 of FIG. 4. The similarity detector 316 can identify and categorize the details associated with each item in the reference table based on the information of the new A/B test. In certain embodiments, after the A/B testing management engine 310 of FIG. 3A obtains information (including UI variants and parameters) for a new A/B test, the similarity detector 316 categorizes the UI variants and parameters associated with the new A/B test into a reference table.

In step 620, the similarity detector 316 calculates the closest point for the details of each item of the reference table. For example, a point is assigned to a detail for a given item. In step 630, the similarity detector 316 sums all of the calculated points of step 630 to generate a score. The score relates the UI variants and the parameters of the new A/B test to extracted A/B testing data from previously performed A/B tests. In certain embodiments, the similarity detector 316 generates a vector representing the assigned points. The vector is unique to the new A/B test.

In step 640, the similarity detector 316 searches the previously performed A/B tests to identify a previous A/B test that is similar to the UI variants and the parameters based on the score. For example, the previous A/B test and the new A/B test can have similar scores indicating that the variants and parameters of the two tests are closely related. In another example, the previous A/B test and the new A/B test can have similar vectors.

In step 650, the similarity detector 316 identifies a confidence score representing a level of similarity between the previous A/B test to the UI variants and the parameters of the new A/B test.

In step 660, the recommendation generator 318 compares the confidence score to various thresholds to generate a recommendation. For example, if the confidence score is above a first threshold (such as 90%), then the similarity detector 316 can recommend a winner. The recommended winner of the new A/B test can be based on the winner of the previously performed A/B test since the two tests are closely related.

In another example, if the confidence score is below a second threshold (such as 70%), then the similarity detector 316 can recommend performing an A/B test. The similarity detector 316 can recommend performing the test since the closest previously performed test is not close enough to the new A/B testing UI variants and parameters.

In yet another example, if the confidence score is within a threshold range (such as the first and second thresholds), then the similarity detector 316 can suggest modifying one or more testing scenarios. For example, the similarity detector 316 can suggest that if one or more parameters are modified to match the parameters of previously performed A/B test, if one or more UI variants are modified to match the UI variants of the previously performed A/B test, or a combination thereof, the two A/B tests (the new A/B test and the previously performed A/B test) can be closer such that the confidence score would be over the first threshold (90%) and a winner can be declared.

Although FIG. 6 illustrates the method 600 for generating recommendations when a new A/B test is obtained, various changes may be made to FIG. 6. For example, the recommendations can be based on different thresholds. In yet another example, while shown as a series of steps, various steps in FIG. 6 could overlap, occur in parallel, or occur any number of times.

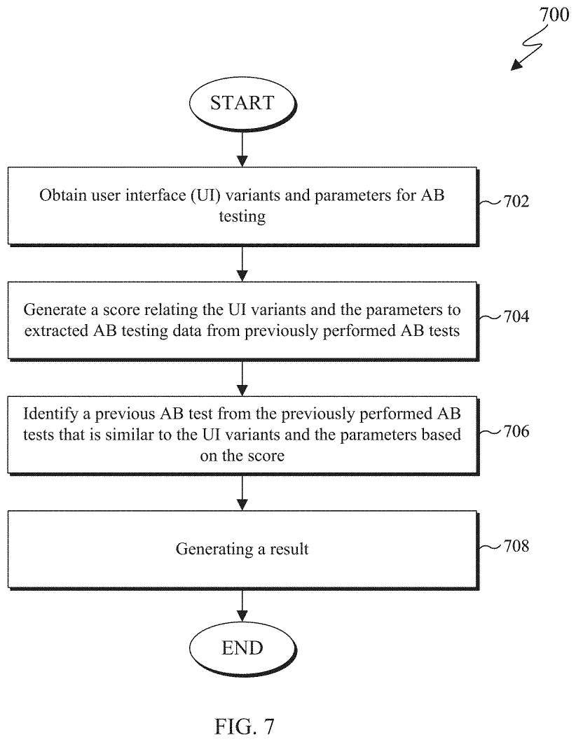

FIG. 7 illustrates an example method 700 for A/B testing in accordance with this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps.

The method 700 can be performed by the server 104 or any of the client devices 106-114 of FIG. 1, the electronic device 201 or the server 206 of FIG. 2, or any other suitable device or system. For ease of explanation, the method 700 is described as being performed by the electronic device 201 that includes the A/B testing system 300 of FIG. 3A. However, the method 700 can be used with any other suitable system.

In step 702, the electronic device 201 obtains UI variants and parameters for a new A/B test. The UI variants can include different positions, fonts, colors, and the like of a user interface. The parameters can specify information about how to run the new A/B test. For example, the parameters can include information such as defining the life cycle of the new A/B test (such as how long the A/B testing is to be performed, when the A/B test is to start, when the A/B test is to conclude, or the like). The parameters can also specify assignment and segmentation information (such as demographic data and information). The parameters can also indicate information about the application to which the UI variants belong (such as a type of application, information defining the types of UIs of the different variants, the type of device expected to execute the application, or the like).

In step 704, the electronic device 201 generates a score relating the UI variants and parameters to extracted A/B testing data from previously performed A/B tests. The score can be generated in response to the electronic device 201 obtaining the UI variants and parameters of step 702.

In order to generate the score, the electronic device 201 can extracts A/B testing data from previously performed A/B tests using a machine learning classifier. In certain embodiments, the machine learning classifier is an action based classifier.

In certain embodiments, to generate the score, the electronic device 201 can categorize the attributes of the new A/B test based on a reference table (such as the reference table 400 of FIG. 4). The reference table can define different categories and subcategories of the UI variants and parameters. The electronic device 201 can assign points to one or more of the attributes that are related to details of the reference table. The score can be based on the assigned points and relates the UI variants and parameters of the new A/B test to previously performed A/B test.

In step 706, the electronic device 201 identifies a previous A/B test from the previously performed A/B tests that is similar to the UI variants and the parameters based on the score. To identify a previous A/B test from the previously performed A/B tests that is similar to the UI variants and the parameters, the electronic device 201 can compare extracted A/B testing data from the previously performed A/B tests. For example, the electronic device 201 can generate a reference table (similar to the reference table 400 of FIG. 4) of the UI variants and parameters of new A/B test and compare that reference table to reference tables associated with the reference table.

In certain embodiments, the electronic device 201 determines whether any of the previously performed A/B tests are similar to the UI variants and the parameters. In response to determining that at least one of the previously performed A/B test is similar to the UI variants and the parameters of the new A/B test, based on the score, the electronic device 201 compares the previously performed A/B tests to identify a single previous A/B test based on the score. If none of the previously performed A/B tests are similar to the UI variants and the parameters of the new A/B test, based on the score, the electronic device 201 performs the A/B test. The new A/B test can be performed by distributing the variants to the two groups of persons based on the parameters for determining which variants perform better. After the A/B testing of the new UI variants are performed, the new UI variants, the parameters, and the results are stored to be analyzed by the UI analyzer 330 of FIG. 3A.

If at least one of the previously performed A/B test is similar to the elements of the new A/B test, the electronic device 201 can generate a confidence score relating the new A/B test to each of the previously performed A/B test. That is, a single confidence score is generated relating the new A/B test to one of the previously performed A/B tests. The confidence score representing a level of similarity between the elements of the new A/B test and each of the previously performed A/B tests that are identified as being similar to the new A/B test. The electronic device 201 can compare the highest confidence score to a threshold to generate a result.

In step 708, the electronic device 201 generates a result. The result can indicate whether one of the UI variants would win an A/B test without actually performing the A/B test on the UI variants and parameters of the new A/B test. The result can be generated based on a comparison of one or more thresholds to similarities between the extracted A/B testing data of the previous A/B test and the UI variants and the parameters.

In certain embodiments, when the confidence score is compared to a first threshold, the electronic device 201 identifies one of the UI variants as a winner without performing the A/B test. For example, if the previously performed A/B test is closely related to the new A/B test, the results of the previous A/B test can be applied to the new A/B test. For example, if the confidence score is above 90%, the electronic device 201 can indicate a winner of the new A/B test based on the winner of the previous A/B test.

In certain embodiments, when the confidence score is compared to a second threshold, the electronic device 201 provides a result indicating that an A/B test should be performed on the UI variants and parameters. The results of the new test, the UI variants, and parameters can be stored and analyzed such as by the UI analyzer 330 of FIG. 3A. For example, if the confidence score is below 70%, the electronic device 201 can indicate that the A/B test should be performed on the UI variants and parameters, as it is not similar to a previously performed A/B test.

In certain embodiments, when the confidence score is compared to a third threshold, the electronic device 201 provides a result indicating a recommendation or suggestion for modifying one or more parameters or one or more UI variants. The electronic device 201 can identify differences between the elements of the new A/B test and a previously performed A/B test, and suggestion one or more modifications to the new A/B test such that it would increase the level of similarity between the new A/B test and the previously performed A/B test. If the modifications are made, the confidence score relating the modified A/B test to the previously performed A/B test can be above the first threshold such as the electronic device 201 can declare a winner. For example, if the confidence score is between 90% and 70%, the electronic device 201 can generate the recommendation.

Although FIG. 7 illustrates one example of a method 700 for A/B testing, various changes may be made to FIG. 7. For example, while shown as a series of steps, various steps in FIG. 7 could overlap, occur in parallel, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. § 112(f).

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for A/B testing comprising:
obtaining user interface (UI) variants and parameters for A/B testing;
in response to obtaining the UI variants and the parameters, generating a score relating the UI variants and the parameters to extracted A/B testing data from previously performed A/B tests;
identifying a previous A/B test from the previously performed A/B tests that is similar to the UI variants and the parameters based on the score; and
generating a result indicating whether one of the UI variants would win an A/B test without performing the A/B testing based on a comparison of one or more thresholds to similarities between the extracted A/B testing data of the previous A/B test and the UI variants and the parameters.

2. The method of claim 1, further comprising:
determining whether any of the previously performed A/B tests are similar to the UI variants and the parameters;
in response to determining that at least one of the previously performed A/B tests are similar to the UI variants and the parameters based on the score, comparing the at least one of the previously performed A/B tests to identify the previous A/B test based on the score;
in response to determining that none of the previously performed A/B tests are similar to the UI variants and the parameters based on the score, performing the A/B testing on the UI variants and the parameters; and
after the A/B testing is performed, storing results of the A/B test, the UI variants and the parameters with the previously performed A/B tests.

3. The method of claim 1, further comprising:
comparing the extracted A/B testing data of the previous A/B test to the UI variants and the parameters to identify the similarities based on the score;
generating a confidence score representing a level of similarity between the extracted A/B testing data of the previous A/B test to the UI variants and the parameters; and
comparing the confidence score to the one or more thresholds to generate the result.

4. The method of claim 3, wherein:
when the result is a first result based on a comparison of the confidence score to a first threshold of the one or more thresholds, the method comprises identifying the one UI variant that would win an A/B test without performing the A/B testing;
when the result is a second result based on a comparison of the confidence score to a second threshold of the one or more thresholds, the method comprises:
performing an A/B test on the UI variants and the parameters, and
storing results of the A/B test, the UI variants and the parameters with the previously performed A/B tests; and
when the result is a third result based on a comparison of the confidence score to a third threshold of the one or more thresholds, the method comprises:
identifying differences between the extracted A/B testing data of the previous A/B test that are similar to the UI variants and the parameters, and
generating a recommendation for modifying at least one of the parameters or the UI variants based on the differences.

5. The method of claim 1, wherein generating the score comprises:
categorizing attributes of the UI variants and the parameters based on items and corresponding details of a reference table;
assigning points to one or more of the attributes that are related to details of the reference table; and
generating the score based on the assigned points, wherein the score relates the UI variants and the parameters to the extracted A/B testing data.

6. The method of claim 5, wherein:
the items define at least one of: a type of application, a type of UI, device type, segmentation data; and metrics; and
the details define subcategories of each of the each of the items.

7. The method of claim 1, further comprising:
obtaining data from the previously performed A/B tests, the data including UI variants and performance data; and
extracting the A/B testing data from the data using a machine learning classifier.

8. The method of claim 7, wherein the A/B testing data is exacted from the previously performed A/B tests using an action based machine learning classifier.

9. An electronic device comprising:
a memory configured to store extracted A/B testing data from previously performed A/B tests; and
a processor configured to:
obtain user interface (UI) variants and parameters for A/B testing,
in response to the UI variants and the parameters being obtained, generate a score relating the UI variants and the parameters to the extracted A/B testing data from the previously performed A/B tests,
identify a previous A/B test from the previously performed A/B tests that is similar to the UI variants and the parameters based on the score, and
generate a result indicating whether one of the UI variants would win an A/B test without performing the A/B testing based on a comparison of one or more thresholds to similarities between the extracted A/B testing data of the previous A/B test and the UI variants and the parameters.

10. The electronic device of claim 9, wherein the processor is further configured to:
determine whether any of the previously performed A/B tests are similar to the UI variants and the parameters;
in response to a determination that at least one of the previously performed A/B tests are similar to the UI variants and the parameters based on the score, compare the at least one of the previously performed A/B tests to identify the previous A/B test based on the score;
in response to a determination that none of the previously performed A/B tests are similar to the UI variants and the parameters based on the score, perform the A/B testing on the UI variants and the parameters; and
after the A/B testing is performed, store results of the A/B test, the UI variants and the parameters with the previously performed A/B tests in the memory.

11. The electronic device of claim 9, wherein the processor is further configured to:
compare the extracted A/B testing data of the previous A/B test to the UI variants and the parameters to identify the similarities based on the score;
generate a confidence score representing a level of similarity between the extracted A/B testing data of the previous A/B test to the UI variants and the parameters; and
compare the confidence score to the one or more thresholds to generate the result.

12. The electronic device of claim 11, wherein:
when the result is a first result based on a comparison of the confidence score to a first threshold of the one or more thresholds, the processor is configured to identify the one UI variant that would win an A/B test without performing the A/B testing;
when the result is a second result based on a comparison of the confidence score to a second threshold of the one or more thresholds, the processor is further configured to:
perform an A/B test on the UI variants and the parameters, and
store results of the A/B test, the UI variants and the parameters with the previously performed A/B tests in the memory; and
when the result is a third result based on a comparison of the confidence score to a third threshold of the one or more thresholds, the processor is further configured to:
identify differences between the extracted A/B testing data of the previous A/B test that are similar to the UI variants and the parameters, and
generate a recommendation for modifying at least one of the parameters or the UI variants based on the differences.

13. The electronic device of claim 9, wherein to generate the score the processor is further configured to:
categorize attributes of the UI variants and the parameters based on items and corresponding details of a reference table;
assign points to one or more of the attributes that are related to details of the reference table; and
generate the score based on the assigned points, wherein the score relates the UI variants and the parameters to the extracted A/B testing data.

14. The electronic device of claim 13, wherein:
the items define at least one of: a type of application, a type of UI, device type, segmentation data; and metrics; and
the details define subcategories of each of the each of the items.

15. The electronic device of claim 9, wherein the processor is further configured to:
obtain data from the previously performed A/B tests, the data including UI variants and performance data; and
extract the A/B testing data from the data using a machine learning classifier.

16. The electronic device of claim 15, wherein the A/B testing data is exacted from the previously performed A/B tests using an action based machine learning classifier.

17. A non-transitory machine-readable medium containing instructions that when executed cause at least one processor of an electronic device to:
obtain user interface (UI) variants and parameters for A/B testing, in response to the UI variants and the parameters being obtained, generate a score relating the UI variants and the parameters to extracted A/B testing data from previously performed A/B tests,
identify a previous A/B test from the previously performed A/B tests that is similar to the UI variants and the parameters based on the score, and
generate a result indicating whether one of the UI variants would win an A/B test without performing the A/B testing based on a comparison of one or more thresholds to similarities between the extracted A/B testing data of the previous A/B test and the UI variants and the parameters.

18. The non-transitory machine-readable medium of claim 17, further containing instructions that when executed cause the at least one processor to:
compare the extracted A/B testing data of the previous A/B test to the UI variants and the parameters to identify the similarities based on the score;
generate a confidence score representing a level of similarity between the extracted A/B testing data of the previous A/B test to the UI variants and the parameters; and
compare the confidence score to the one or more thresholds to generate the result.

19. The non-transitory machine-readable medium of claim 18, wherein:
when the result is a first result based on a comparison of the confidence score to a first threshold of the one or more thresholds, the non-transitory machine-readable medium further contains instructions that when executed cause the at least one processor to identify the one UI variant that would win an A/B test without performing the A/B testing;
when the result is a second result based on a comparison of the confidence score to a second threshold of the one or more thresholds, the non-transitory machine-readable medium further contains instructions that when executed cause the at least one processor to:
perform an A/B test on the UI variants and the parameters, and
store results of the A/B test, the UI variants and the parameters with the previously performed A/B tests in a memory; and
when the result is a third result based on a comparison of the confidence score to a third threshold of the one or more thresholds, the non-transitory machine-readable medium further contains instructions that when executed cause the at least one processor to:
identify differences between the extracted A/B testing data of the previous A/B test that are similar to the UI variants and the parameters, and
generate a recommendation for modifying at least one of the parameters or the UI variants based on the differences.

20. The non-transitory machine-readable medium of claim 17, further containing instructions that when executed cause the at least one processor to:
obtain data from the previously performed A/B tests, the data including UI variants and performance data; and
extract the A/B testing data from the data using an action based machine learning classifier.
